(19) United States
(12) Patent Application Publication
(10) Pub. No.: US 2010/0251606 A1
(43) Pub. Date: Oct. 7, 2010

(54) GRAFT MODIFIED VINYL ESTER AND ETHYLENE POLYMERS, PREPARATION METHOD THEREOF AND USE OF SAME AS ADDITIVES THAT IMPROVE THE COLD PROPERTIES OF LIQUID HYDROCARBONS

(75) Inventors: Frédéric Tort, Brignais (FR); Géraldine Papin, Lyon (FR); Valérie Heroguez, Merignac (FR)

Correspondence Address: HARNESS, DICKEY & PIERCE, P.L.C., P.O. BOX 828, BLOOMFIELD HILLS, MI, 48303, US

(73) Assignee: TOTAL RAFFINAGE MARKETING, Puteaux (FR)

(21) Appl. No.: 12/670,974

(22) PCT Filed: Jul. 25, 2008
(86) PCT No.: PCT/FR08/01119

§ 371 Date: Jan. 27, 2010

(30) Foreign Application Priority Data
Jul. 27, 2007 (FR) 0705514

(51) Int. Cl. C10L 1/195; C08F 22/20; C08F 4/42; C08K 5/01

(52) U.S. Cl. 44/400; 526/320; 526/172; 524/81

(57) ABSTRACT

This disclosure concerns the synthesis and use of novel polymers based on ethylene and vinyl esters, modified by conjugation to improve their solubility in liquid hydrocarbons, as double-purpose additives to improve the filterability and flow of liquid hydrocarbons at low temperatures, in particular for middle distillates derived from the distillation of petroleum and crude oil.

### CROSS-REFERENCE TO RELATED APPLICATIONS

This application is a National Phase Entry of International Application No. PCT/FR2008/001119, filed on Jul. 25, 2008, which claims priority to French Application 07 05514, filed on Jul. 27, 2007, both of which are incorporated by reference herein.

### TECHNICAL SCOPE

This invention concerns the synthesis and use of novel polymers based on ethylene and vinyl esters, modified by conjugation to improve their solubility in liquid hydrocarbons and depress their viscosity, as double-purpose additives to improve the filterability and flow of liquid hydrocarbons at low temperatures, in particular for middle distillates derived from the distillation of petroleum and crude oil.

### TECHNICAL CONTEXT AND BACKGROUND ART

For many years, the petroleum industry has been developing additives to improve the low-temperature filterability of fuel products in the form of polymers of ethylene and vinyl acetate and/or vinyl propionate (EVA and EVP), referred to as LFT (limiting filterability temperature) additives. These additives affect the crystallisation process by cutting down the growth and size of paraffin crystals formed at low temperatures (e.g. below 5° C.) so that they pass through the filters inside internal combustion engines or heating installations. Such additives—which are perfectly familiar to all those skilled in the art—are systematically added to classic-type middle distillates at the oil refinery. Distillates treated in this way are used as fuel for diesel engines or heating systems. Greater quantities of these additives can be added to fuel products sold in service stations, notably for very low temperature applications.

Other types of additive such as copolymers of ethylene, vinyl acetate and branched vinyl esters such as the vinyl neodecanoates (VeoVA) with a role in LFT have been described, notably in US 2004/0226216. To improve both the distillate's LFT and pour point, in addition to these LFT additives (EVA or EVP), other substances can be added which act either on their own or in association with said additives to depress the limiting filterability temperature and the low-temperature flow of conventional hydrocarbon distillates. Such combinations of additives both improving LFT and flow temperature at low temperature are described in the prior art.

U.S. Pat. No. 3,275,427 describes a middle distillate boiling between 177° C. and 400° C. containing an additive composed of 90-10% wt. of an ethylene copolymer including 10-30% vinyl acetate with a molecular weight of 1,000-3,000, plus 10-90% wt. of lauryl polyacrylate and/or lauryl polymethacrylate with a molecular weight of 760 to 100,000. It is noted that a combination of these polyacrylates and EVA improves both LFT (measured according to the NF EN116 Norm) and pour point temperature (measured according to the NF 60105 Norm).

For the piping of crude oil and heavy distillates, the authors of U.S. Pat. No. 3,726,653 were confronted with the problem of improving flow, especially at the low temperatures at which such products can get blocked inside the pipes. To improve these properties in hydrocarbon compositions containing paraffins of which 5-20% have a boiling point of over 350° C. and a softening point at over 35° C., the inventors propose adding to these compositions between 10 ppm and 2% wt. of a mixture of a polymer of an olefin ester of carboxylic acids with 3-5 carbon atoms, plus an alcohol with 14-30 carbon atoms and a molecular weight of between 1,000 and 1,000,000, plus an ethylene-vinyl acetate copolymer (EVA) with 1-40 (preferably 14-24) vinyl acetate residues with a mean molecular weight of 20,000-60,000, the molar ratio of the olefin ester polymer to the ethylene-vinyl acetate copolymer ranging from 0.1 to 10. To control the size of paraffin crystals at a concentration of less than 3% in middle distillates boiling between 120° C. and 480° C., the authors of U.S. Pat. No. 4,156,422 propose adding 10 ppm to 1% wt. of a mixture of a homopolymer of an olefin ester of acrylic or methacrylic acid containing an alkyl chain of 14-16 carbon atoms and with a molecular weight of ranging from 1,000 to 200,000, plus an ethylene-vinyl acetate copolymer with a mean molecular weight of below 4,000, the molar ratio of the olefin ester homopolymer to the ethylene-vinyl acetate copolymer ranging from 0.1:1 to 20:1. Nevertheless, starting fractions have become diversified in recent years and modern middle distillates have compositions quite different from the old middle distillates for which the original filterability additives were conceived, notably those based on EVA and EVP copolymers. Moreover, changes in specifications in the year 2,00, and more recently in 2005, have changed the way refiners formulate distillates for use in both diesel motors and domestic oil heating systems. Most of the distillates used come from refining operations, notably direct hydrocarbon distillation, thermal cracking processes, hydro-cracking and/or catalytic cracking, and visco-reduction processes.

With the increasing demand for diesel fuel, refiners are seeking to introduce fractions into the composition from sources other than petroleum but these can pose problems in fuel products because they compromise low-temperature performance by raising the LFT and pour temperature. Such new sources include:
heavier fractions derived from cracking and visco-reduction processes, with high concentrations of heavy paraffin species (more than 18 carbon atoms),
synthetic distillates derived from the conversion of gases such as those generated in the Fischer Tropsch process,
synthetic distillates derived from the processing of biological material from plants or animals, e.g. NexBTL,
plant- or animal-derived oils and/or oil esters.
   These new fuel sources can be used on their own or mixed with petroleum-derived middle distillates as the fuel base. They contain long-chain paraffins with 16 carbon atoms or more.

It was observed that the LFT of distillates obtained by combining petroleum-derived material with fractions from these new sources was relatively high, and that the addition of a conventional filterability additive (e.g. EVA and/or EVP) does not necessarily adequately depress their filterability temperature. Moreover, these additives do not always dissolve as well in the new compositions. The same phenomenon has been observed with middle distillate fractions from newer crude products arriving on the market which contain a higher concentration of long-chain paraffins than traditional refinery products.

There exists therefore a need to adapt the filterability additives for these new distillate sources, and find solutions to improve both their pour point and solubility. One of the approaches adopted by the Applicant is to enhance the ability of classic filterability additives (ethylene-vinyl ester copolymers) to depress the limiting filterability temperature of new middle distillate bases as well as their admixability with classic distillates, by making chemical changes to said ethylene-vinyl ester copolymers in the form of the addition of conjugated groups all along the polymer chain. The conjugated groups would enhance the solubility of these ethylene-vinyl ester copolymers in the new bases without compromising their performance as modifiers of crystallisation, and therefore their efficacy vis-à-vis limiting filterability temperature and pour point.

U.S. Pat. No. 4,161,452 describes the conjugation of polymerisable monomers, e.g. by grafting unsaturated carboxylic acids onto olefin polymers using a free radical-mediated reaction in the presence of an initiator. U.S. Pat. No. 6,106,584 describes copolymers with ethylene groups and groups (two or more) derived from monomers of acrylate and methacrylate alkyl ester esterified with alkyl groups containing up to 15 carbon atoms. These copolymers are made using classic, free radical-mediated polymerisation reactions with initiators at high pressure; such methods are difficult to implement.

US 2006/0137242 describes anti-sedimentation additives for mineral oil distillates (notably middle distillates) with low sulphur content, designed to improve the flow properties of said oils and particularly the dispersion of paraffins at low temperatures. These additives are conjugated copolymers which can be generated by conjugating an acrylate alkyl ester (C8-C22) onto an EVA copolymer containing 3.5 to 21% molar vinyl acetate, preferably with a molecular weight (Mn) of between 1,000 and 10,000 g/mol.

US 2007/0157509 also describes anti-sedimentation additives for mineral oil distillates (notably middle distillates) with low sulphur content, designed to improve the flow properties of said oils and particularly the dispersion of paraffins at low temperatures. These additives are conjugated copolymers which can be generated by conjugating an acrylate alkyl ester (C8-C22) onto an copolymer of ethylene and 0.5 to 16% molar of at least one vinyl ester CH₂═CH—OCO—R¹ containing no more than 3.5% molar vinyl acetate. Preferably, these copolymers have a Mn of between 1,000 and 10,000 g/mol, and are preferably used together with another co-additive like a phenol alkyl resin, as well as a LFT additive such as EVA.

A less conventional way of introducing polymeric branches along a polymer chain has been described by Garcia F. G. et al. in Eur Polym J. 2002, 38, 759. This involves conjugating a polymethylmethacrylate onto an EVA copolymer by means of an atom transfer radical polymerisation (ATPR) reaction in the presence of a catalyst of CuCl and bipyridine at 80° C., which results in a conjugation efficiency of over 12%. This type of technique is easier to implement because high pressure is not necessary.

### SUMMARY OF THE INVENTION

The first object of this invention concerns novel ethylene-vinyl ester copolymers, chemically modified by the conjugation of branches. Chemical modification of an ethylene-vinyl ester copolymer not only depresses the polymer's viscosity but also enhances its solubility in liquid hydrocarbons, while preserving or even improving its efficacy at inhibiting the crystallisation of paraffins present in the hydrocarbons. Another object of the invention concerns a process for the preparation of these new polymers, notably based on an ATRP reaction suitable for the chemical conjugation of EVA polymers with polyacrylates, constituting a better ATRP process than that described in the literature.

The application specifically concerns additives for distillate-type bases for diesel and domestic heating fuels which contain a high paraffin content and low aromatic content (and therefore low dissolving power). This invention has the advantage of yielding less viscous polymers that readily dissolve in hydrocarbons which can be used as filterability additives for hydrocarbons. The enhanced solubility conferred by ethylene-vinyl ester polymer conjugation means that hydrocarbons treated with the conjugated polymers preserve their initial filterability characteristics at room temperature and readily pass through the type of filter that is found upstream in the feed system of engines and domestic heating installations. Moreover, the reduced viscosity conferred by conjugation of the polymers makes it possible to raise the concentration of the polymer in hydrocarbons with low aromatic content, without compromising the ease with which these solutions can be pumped and exploited (viscosity and rheological constraints in pumping and injection systems).

To this end, this invention proposes a conjugated ethylene-vinyl ester polymer, with a molar mass of over 10,000 g.mol⁻¹ comprising:
a) an ethylene-derived group of structure A —(CH₂—CH₂)ₙ— in which n is a whole number of between 45 and 650;
b) at least one group of structure B: —(CH₂—CHOCOR₁)ₘ₋ₓ— in which m is a whole number of between 5 and 110, and R₁ is at least one residue selected from the groups of linear or branched alkyl groups (C₁-C₁₅);
c) a group of structure C: —(CH₂—CHOH)ₓ₁— in which x₁ is between 0 and 0.95 x;
d) at least one group of structure D: —(CH₂—CHG)ₓ₂- or D′: —CH₂C(OCOCH3)Q)ₓ₂- in which x₂ is never 0 but ranges from 0.05 x and x, preferably x₂ is the same as x, and G corresponds to a group of structure G1 or G2 or G3 in which
   G1 corresponds to the structure —OCOCHCH₃Q-
   G2 corresponds to the structure —OCOCH²Q-
   G3 corresponds to the structure —OCOCH₂SQ-
   in which Q corresponds to:
      either a group of structure Q1 —(CH₂—CZCOOR)ₚ₁—X_{q} in which p₁ ranges from 1 to 800;
      or a group of structure Q2 —(CH₂—CZOCOR)ₚ₂—X_{q} in which p₂ ranges from 1 to 100;
      in which X represents a halogen atom, preferably Br or I, q ranges from 0 to 1, Z corresponds to a hydrogen atom or a CH₃ group, and R corresponds to a linear or branched alkyl group, either saturated or unsaturated, C₁-C₃₀, preferably C₄-C₁₅;
a copolymer in which:
x=x₁+x₂ and x ranges from 0.25 to 55;
the molar percentage of A groups in the polymer is 29-97% in moles;
the molar percentage of B groups in the polymer is 1-20% in moles;
the molar percentage of C groups in the polymer is 0-10% in moles;
the molar percentage of D or D′ groups in the polymer is 0.6-64% in moles and the molar percentage of Q in D or D′ is 8.2-99.9% in moles.

According to one embodiment, the conjugated ethylene-vinyl ester polymer has a molecular weight of 10,500 to 30,000 g.mol⁻¹, and contains:
a) an ethylene-derived group of structure A —(CH₂—CH₂)ₙ— in which n is a whole number of between 45 to 650, preferably 75 to 520.
b) at least one group of structure B: —(CH₂—CHOCOR₁)ₘ₋ₓ— in which m is a whole number of between 5 to 110, preferably 10 to 75, and R₁ is at least one residue selected from the groups of linear or branched alkyl groups C₁-C₁₅;
c) one group of structure C: —(CH₂—CHOH)ₓ₁— in which x₁ ranges from 0 to 0.95 x, preferably x₁ is 0;
d) at least one group of structure D: —(CH₂—CHG)ₓ₂- in which x₂ is never 0 but ranges from 0.05 x to x, preferably x₂ is x, and G corresponds to a group of structure G1 —OCOCHCH₃Q- in which Q corresponds to:
   either one group of structure Q1 —(CH₂—CZCOOR)ₚ₁—X_{q} in which p₁ ranges from 1 to 800, preferably from 1 to 50;
   or one group of structure Q2 —(CH₂—CZOCOR)ₚ₂—X_{q} in which p₂ ranges from 1 to 100, preferably from 1 to 10;
   in which X corresponds to a halogen atom, preferably Br, q ranges from 0 to 1, Z corresponds to a hydrogen atom or a CH₃ group, and R corresponds to a linear or branched alkyl group, either saturated or unsaturated, C₁-C₃₀, preferably C₄-C₁₅;
a copolymer in which:
x=x₁+x₂ and x ranges from 0.25 to 55 preferably from 0.5 to 40;
the molar percentage of A groups in the polymer is 29-97% in moles, preferably 54-90% in moles;
the molar percentage of B groups in the polymer is 1-20% in moles preferably 3.5-11% in moles;
the molar percentage of C groups in the polymer is 0-10% in moles, preferably 0% in moles;
the molar percentage of D groups in the polymer is 0.6-64% in moles preferably 2.3-42% in moles and the molar percentage of Q in D ranges from 8.2-99.9% in moles, preferably from 35-98.7% in moles.

Preferably, in the invention's copolymers Q represents a group of structure Q1 —(CH₂—CZCOOR_{q1})ₚ₁—X_{q} in which q is 0, p₁ ranges from 1 to 50. Preferably, in the invention's copolymers R_{q1} corresponds to a linear or branched alkyl group, either saturated or unsaturated, C₆-C₁₅ preferably C₆-C₁₂, more preferably still 2-ethylhexylacrylate. Preferably, in the invention's copolymers, Q represents a group of structure Q2 —(CH₂—CZOCOR_{q2})ₚ₂—; in which q is 0, p₂ ranges from 1 to 10, Z is H, and R_{q2} corresponds to a branched alkyl group, C₅ to C₂₅ preferably C₅ to C₁₅ in which the branch is at any point of the alkyl group, preferably in position 2 or 3 of the alkyl chain, preferably in such a way as to generate a tertiary carbon. Preferably, in the invention's copolymers, the OCOR_{q2} group is selected from the groups of pivalate, isopentanoate, isohexanoate, 2-ethylhexanoate, isononanoate, isodecanoate, isotridecanoate, neononanoate, neodecanoate or neoundecanoate. Preferably, in the invention's copolymers, the OCOR_{q2} group comes from plant- and/or animal-derived fatty acids in which the R_{q2} group carries saturated or unsaturated, linear or branched alkyl chains, C₈ to C₂₅, preferably C₁₂ to C₁₅.

According to one embodiment, in the invention's copolymers, the group of structure B corresponds to:
a) either a group of structure B′ —(CH₂—CHOCOR′₁)_{m′-x} in which R′₁ is a CH₃ group, and m′ ranges from 10 to 75;
b) or a group of structure B″ —(CH₂—CHOCOR″₁)_{m″-x} in which R″₁ is a C₂H₅ group, and m″ ranges from 10 to 75;
c) or a group of structure B′″ —(CH₂—CHOCOR′″₁)_{m′″-x} in which R′″₁ is a branched alkyl group, C₅ to C₁₅, in which the branch point may be anywhere in the alkyl chain, preferably in position 2 or 3 of the alkyl chain, preferably in such a way as to generate a tertiary carbon, and m′″ ranges from 10 to 75;
   or a mixture thereof, preferably a mixture of groups B′ and B″ or of groups B′ and B″′ or of groups B″ and B′″.

According to one embodiment, in the copolymer according to the invention:
n=79 to 515;
the group of structure B represents a group of structure B′ —(CH₂—CHOCOR′₁)_{m′-x} in which R′₁ is a CH₃ group, and m′ ranges from 10 to 71;
x ranges from 0.5 to 36 with x₁=0.
Q represents a group of structure Q1 —(CH₂—CHCOOR)ₚ₁—X_{q} in which q is 0, p1 ranges from 1 to 50, and R corresponds to a linear or branched alkyl group, either saturated or unsaturated, C₁-C₃₀, preferably C₄-C₁₅, advantageously C₆-C₁₅ and more advantageously still C₆-C₁₂, and more particularly 2-ethylhexylacrylate,
the molar percentage of A groups in the polymer is 54-90% in moles,
the molar percentage of B groups in the polymer is 3.5%-11% in moles,
the molar percentage of C groups in the polymer is 0% in moles,
the molar percentage of D groups in the polymer is 2.3%-42% in moles
and the molar percentage of Q in the group D is 35%-98.7% in moles.

Another object of the invention concerns a process for the preparation of conjugated polymers according to the invention, including the following steps:
i) supply of a starting ethylene-vinyl ester polymer containing:
   a) ethylene-derived groups of structure A —(CH₂—CH₂)ₙ—
   b) at least one group of structure B: —(CH₂—CHOCOR₁)ₘ— in which R₁ is at least one residue selected from the groups of linear or branched alkyls C₁-C₁₅; a CH₂SH or a CH₂I group; n and m ranging so that the mean Mn of the starting polymer ranges from 3,000 to 20,000 g.mol⁻¹; followed by
ii) introduction of a free radical initiator and then a radical-catalysed polymerisation reaction at the priming sites of a polymerisable monomer of structure M1 CH₂═CZCOOR, or possibly of structure M2 CH₂═CZOCOR, monomer M1 or M2 in which Z corresponds to a hydrogen atom or a CH₃ residue, the group R corresponds to a linear or branched alkyl group, either saturated or unsaturated, C₁-C₃₀, reacting so that the extent of polymerisation p1 of the monomer M1 to give the group Q1 at the priming site goes from 1 to 800, or possibly the extent of polymerisation p2 of the monomer M2 to give the group Q2 at the priming site goes from 1 to 100.

According to one embodiment, the preparation process for the conjugated polymer according to the invention includes the following steps:
j) supply of a starting ethylene-vinyl ester polymer containing:
   a) ethylene-derived groups of structure A —(CH₂—CH₂)ₙ—
   b) at least one group of structure B: —(CH₂—CHOCOR₁)ₘ— in which R₁ is at least one residue selected from the groups of linear or branched alkyls C₁-C₁₅; n and m ranging so that the mean Mn of the starting polymer ranges from 3,000 to 20,000 g.mol⁻¹; followed by
jj) partial hydrolysis of the alkyl esters present in the group B such that the hydrolysis efficiency is less than or equal to 50% of the hydrolysable sites, preferably less than 20% of said sites; followed by
jjj) at least partial esterification of these sites with a halide of halogenic acid of structure XOC—CH₂₋ⱼXⱼ—CH₃ in which j is 1 or 2 and X represents a halogen atom, preferably Cl, such that the esterification efficiency is greater than 50%, preferably 80%, or more preferably still 100%; followed by
jjjj) polymerisation at the priming sites carrying a halogen atom, of a monomer of structure M1 CH₂═CZCOOR, or of a monomer of structure M2 CH₂═CZOCOR, a monomer in which Z corresponds to a hydrogen atom or a CH₃ group, the group R corresponds to a linear or branched alkyl group, either saturated or unsaturated, C₁-C₃₀, reacting in such a way that the extent of polymerisation p1 of the monomer M1 to give the group Q1 at the priming site goes from 1 to 50, or the extent of polymerisation p2 of the monomer M2 to give the group Q2 at the priming site goes from 1 to 6.

According to one embodiment of the preparation process according to the invention, the step jjjj) is achieved by atom transfer radical polymerisation (ATRP) in the presence of a catalytic system including a transition metal, preferably a copper halide such as CuBr, and a nitrogen-containing ligand. According to another embodiment of the preparation process according to the invention, the step jjjj) is achieved through a free radical-mediated reaction in the presence of a free radical initiator. According to another embodiment of the preparation process according to the invention, the step jj) is followed by a step kkk) involving the conjugation of a functionalised polyacrylate of structure TOC—(CH2—CHCOOR)ₚ₁— in which p1 and R are the same as those defined above and T represents a halogen atom, in particular Cl or a OH group, at the copolymer's partially hydrolysed alcohol groups generated in step jj). Preferably, in the process according to the invention, the efficiency of conjugation in the weight of copolymer Q1 or Q2 groups generated by the polymerisation of monomers of type M1 or M2 at said priming sites is from 10 to 80%, preferably from 15 to 70%. Another object of the invention concerns a concentrated solution of a polymer according to the invention in a hydrocarbon distillate, preferably a concentration of over 50% by weight, preferably from 60 to 80% by weight.

Another object of the invention concerns using the concentrated solution as an additive to improve the filterability and flow of middle distillate-type hydrocarbons. Preferably, this application concerns hydrocarbons with a concentration of n-paraffins containing more than 18 carbon atoms of over 4% wt. Preferably, the concentrated solution according to the invention is used as a base for a diesel engine fuel or a domestic heating oil.

Another object of the invention concerns a double-purpose additive designed to depress the low-temperature filterability and flow of liquid hydrocarbons containing a conjugated polymer according to the invention. Another object of the invention concerns middle distillates containing at least a major component of a middle distillate-type hydrocarbon fraction with a sulphur content of less than 5,000 ppm, preferably less than 500 ppm, and more preferably still less than 50 ppm, and a minor component of at least one double-purpose filterability and flow additive as defined above.

Preferably, in the distillates according to the invention, the major component is constituted by distillates boiling at 150-450° C., the crystallisation commencement temperature Tcc being greater than or equal to −5° C., preferably between −5° C. and +10° C., and contains distillates from direct distillation, vacuum distillates, hydroprocessed distillates, distillates generated by catalytic cracking and/or hydro-cracking of vacuum distillates, distillates resulting from ARDS (atmospheric residue desulphuration) and/or visco-reduction conversion processes, distillates from the recovery of Fischer Tropsch fractions, distillates generated by BTL (Biomass-to-liquid) conversion of plant- and/or animal-derived biological material, alone or combined, and esters of plant- and/or animal-derived lipids, or mixtures thereof. Preferably, the distillates according to the invention contain a concentration of n-paraffins containing more than 18 carbon atoms of over 4% by weight. Preferably, the distillates according to the invention have a weight content of n-paraffins with a carbon number of over 24 greater than or equal to 0.7%. Preferably, the distillates according to the invention have a weight content of n-paraffins with a carbon number of ranging from C24 to C40 ranging from 0.7 to 2%.

Another object of the invention concerns diesel fuels containing 0-500 ppm sulphur and at least one distillate according to the invention. Preferably, the fuel contains a distillate according to the invention in which the minor component contains 10-5,000 ppm of at least one double-purpose filterability and flow additive as described above, possibly mixed with other additives such as detergents, dispersing agents, de-emulsifying agents, anti-foaming agents, biocides, deodorants, ketane improvers, anti-corrosion agents, and modifiers of friction, lubrication, combustion, cloud point, pour point, sedimentation and conductivity.

Another object of the invention concerns heating fuels containing 0-5,000 ppm sulphur and at least one distillate according to the invention. Another object of the invention concerns heavy domestic oils containing at least one distillate according to the invention. Other characteristics and advantages of the invention will emerge from the following detailed description and the invention's preferred embodiments.

### DETAILED DESCRIPTION OF EMBODIMENTS

Description of Starting Polymers

The starting ethylene-vinyl ester copolymers used in the process of the invention are statistical copolymers comprising:
a) an ethylene-derived group of structure A —(CH₂—CH₂)ₙ—
b) at least one group of structure B: —(CH₂—CHOCOR₁)ₘ— in which R₁ is at least one residue selected from the groups of linear or branched alkyl groups C₁-C₁₅; the group CH₂SH or CH₂I; n and m ranging so that the mean Mn of the starting polymer ranges from 3,000 to 20,000 g.mol⁻¹, preferably from 5,000 to 15,000 g.mol⁻¹. Preferably n is a whole number of between 45 and 650 and m is a whole number of between 5 and 110.

According to a particular embodiment, the group of structure B represents:
a) either a group of structure B′ —(CH₂—CHOCOR′₁)_{m′} in which R′₁ is a CH3 group, and m′ ranges from 10 to 75;
b) or a group of structure B″ —(CH₂—CHOCOR″₁)_{m″} in which R″₁ is the group C₂H₅, and m″ ranges from 10 to 75;
c) or a group of structure B′″ —(CH₂—CHOCOR′″₁)_{m′″} in which R′″ is a branched alkyl chain of C₅ to C₁₅ in which the branch point may be anywhere in the alkyl chain, preferably in position 2 or 3 of the alkyl chain, preferably in such a way as to generate a tertiary carbon, and m′″ ranges from 10 to 75;
or a mixture thereof, preferably a mixture of groups B′ and B″ or a mixture of groups B′ or B″ with B′″.

Preferably the group OCOR₁ is an EVA vinyl acetate or an EVP vinyl propionate or an EVeo vinyl neoalkanoate. Groups of structure B can also be used in which R₁ is a CH₂SH or CH₂I group. It is the number m of ester groups, and their statistical distribution along the chain which dictates the mean length of the polyethylene segments and, in consequence, the polymer's solubility in diesel. EVA and/or EVP and/or EVeo can incorporate into the paraffin crystal and thereby modulate the crystallisation process, affecting the size and configuration of the crystals formed. In the case c) pertaining to the group of structure B′″, the branched alkyl ester groups are C₅ to C₁₅ groups in which the branch point may be anywhere in the alkyl chain, preferably in position 2 or 3 of the alkyl chain, preferably in such a way as to generate a tertiary carbon. Preferably the group neoalkanoate OCOR′″ is selected from the groups of pivalate, isopentanoate, isohexanoate, 2-ethylhexanoate, isononanoate, isodecanoate, isotridecanoate, neononanoate, neodecanoate and neoundecanoate.

General Description of Preparation Processes for the Conjugated Polymers According to the Invention

The preparation process for polymers based on ethylene and vinyl esters according to the invention involves free radical initiators like peroxide. This agent initiates the free radical-mediated polymerisation reaction of a vinyl monomer substituted on the starting ethylene-vinyl ester copolymer as described above. In the course of this step, priming sites are created at which copolymerisation of the monomer proceeds in a classic, free radical-mediated polymerisation process.

This involves either the intermediate formation of a free radical C° on the skeleton of the starting ethylene-vinyl ester polymer at the tertiary carbon of the group B, i.e. —(CH₂—C°OCOR₁)ₘ—, or the formation of a free radical C° on the ester group branched on the ester group of the starting ethylene-vinyl ester polymer at the first carbon of the alkyl group R₁ of the group B, i.e. —(CH₂—CHOCOC°HR₁)ₘ—. Then free radical-mediated polymerisation proceeds in the presence of a substituted vinyl monomer which can be polymerised at the priming site with the free radical C°. When the group R₁ is a CH₂SH or CH₂I group, polymerisation of the substituted vinyl monomer proceeds with either the S atom or the iodine-carrying carbon atom as the priming site.

According to another embodiment, the starting ethylene-vinyl ester polymer is preliminarily activated by introducing halogenated priming sites prior to polymerisation of the substituted vinyl monomer. In this case, this polymerisation can be carried out using either an atom transfer process (ATRP) in the presence of a catalytic system, or a classic, free radical-mediated polymerisation reaction in the presence of a free radical initiator. The ATRP process is undertaken in the presence of a catalytic system including a transition metal and a nitrogen-containing ligand. This can generate a copolymer conjugated with substituted ethylene groups, possibly carrying a halogen atom.

To achieve conjugation of the vinyl ester monomer by ATRP, the copolymer has first to be activated by creating priming sites. Such an activated copolymer is generated by firstly partially hydrolysing the OCOR₁ residues of group B on the polymer chain, and then esterifying them all. This procedure based on hydrolysis followed by esterification is analogous to that described by Garcia F. G. et al. in Eur Polym J. 2002, 38, 759.

Thus, the activated ethylene-vinyl ester copolymer is generated by preliminary partial hydrolysis of the esters in group B of a starting ethylene-vinyl ester copolymer as described above. The hydrolysis is carried out by alkaline methanolysis, and the conversion efficiency of vinyl ester groups into vinyl alcohol is dependent on the volume of alkali used. By varying the rate of hydrolysis in step a) of the process, the number of conjugates Q branched on the final copolymer can be controlled. This hydrolysis step is followed by complete or partial esterification of the resultant vinyl alcohol groups by a halide of an alpha-halogenated acid, preferably 2-chloro-propionate chloride or, according to a variant, a halide of a dihalogenated alpha acid such as dichloroacetyl chloride.

To generate the conjugated polymer of the invention through atom transfer radical polymerisation (ATRP), the process described by Garcia F. G. et al. in Eur Polym J. 2002, 38, 759 is adapted to the special problem of the starting ethylene-vinyl ester copolymers generally used in diesel fuels, the molecular weights of which tend to range from 5,000 to 20,000. In consequence, the catalytic system used in the invention includes a halide of a metal belonging to the group of transition metals, preferably a copper halide, or more preferably still CuBr. It has been observed that the polymerisation reaction proceeds faster with CuBr than with CuCl. The catalytic system used in the invention also contains a nitrogen-containing ligand, preferably a polyalkylamine of structure H—[NR—(CH₂)ᵢ—]ⱼ—NH₂(I), in which R is a hydrogen atom or a hydrocarbon radical containing 1-10 carbon atoms, i and j being whole numbers ranging from 2 to 10, preferably from 2 to 5. Preferably, the polyamine is pentamethyldiethylenetriamine (PMEDTA). Thus the combination of CuBr and PMEDTA gives the best results and ensures better priming and better polymerisation control, notably finer size distribution.

Conjugation of the activated copolymer is then achieved by ATRP (atom transfer radical polymerisation) in the presence of a catalytic system including a transition metal and a nitrogen-containing ligand. During this step, controlled polymerisation is carried out on a vinyl ester monomer with a chain containing 1 to 30 carbon atoms, preferably acrylic, at the halogenated priming sites. This polymerisation at the priming site makes it possible to graft on polyester residues, more particularly polyacrylate residues. This step has been modified from that described by Garcia to take into account the structures and properties of the polyacrylates used in the invention.

Thus the catalytic system is preferably based on CuBr to increase the reaction rate and facilitate exchange. The catalytic system preferably uses pentamethyldiethylenetriamine (PMEDTA) to enhance priming and ensure better polymerisation control, notably finer size distribution. This reaction is advantageously carried out in an aromatic solvent, preferably toluene, at a temperature of between 30° C. and 120° C., for 1-10 hours, preferably 3 hours at 80° C. The molar ratio of primer/CuBr/ligand varies around the stiochiometry.

According to a variant, conjugated polymers according to the invention can also be generated using a conventional, free radical-mediated polymerisation process in the presence of a free radical initiator, on the activated copolymer carrying priming sites. This variant is particularly interesting for industrial-scale applications in which it is more difficult to control the polymerisation reaction and polymer chain length than with the ATRP process. According to another variant, conjugated polymers according to the invention can also be generated by direct coupling, onto the alcohol groups of a partially hydrolysed copolymer as described above, of a functionalised polyacrylate of structure TOC—(CH₂—CHCOOR)ₚ₁— in which p1 and R are as they are defined above, and T represents a halogen atom, in particular Cl, or an OH group. This corresponds to room-temperature esterification in the presence of an amine like pyridine at a stoichiometric ratio.

Description of Substituted Vinyl Monomers

Polymerisation at priming sites carrying either a free radical or a halogen atom, is achieved with substituted vinyl monomers of two types: Preferably, use is made of a monomer of structure M1 CH₂═CZCOOR, in which Z corresponds to a hydrogen atom or a CH₃ group, the group R corresponds to a linear or branched alkyl group, either saturated or unsaturated, C₁-C₃₀, i.e. methacrylic and/or acrylic esters which give polymethacrylate or polyacrylate polymers. The M1 methacrylic and/or acrylic ester monomer is chosen from among compounds in which the R group contains 1-30 carbon atoms, may contain mono- or poly-aromatic residues, preferably with 2-20 carbon atoms and more preferably still 4-18 carbon atoms, or 6-15 carbon atoms, or 6-12 carbon atoms. The preferred M1 ester monomers are chosen from poly (2-ethylhexylacrylate) and lauryl polyacrylatee with a particular preference for poly (2-ethylhexylacrylate).

Use is also made of a monomer of structure M2 CH₂═CZOCOR, in which Z corresponds to a hydrogen atom or a CH₃ group, and the group R corresponds to a linear or branched alkyl group, either saturated or unsaturated, C₁-C₃₀. Preferably, the group R in M2 here represents a branched alkyl group of C₅ to C₁₅ in which the branch point may be anywhere in the alkyl chain, preferably in position 2 or 3 of the alkyl chain, preferably in such a way as to generate a tertiary carbon. Preferably the group OCOR is selected from the groups of pivalate, isopentanoate, isohexanoate, 2-ethylhexanoate, isononanoate, isodecanoate, isotridecanoate, neononanoate, neodecanoate and neoundecanoate.

Because of the presence of polar groups, these monomers create conjugated polymers which can block the growth of paraffin crystals. Moreover, these conjugates can also promote the formation of new seed points and thereby induce a dispersing effect, both useful properties when it comes to low-temperature applications. These ester monomers were chosen because they generate polymers with a vitreous transition temperature Tg of over −80° C., preferably between −80° C. and −50° C. Their alkyl group is not too long, varying from 1-15 carbon atoms. In consequence, they help reduce the viscosity of the final copolymer.

Structures and Properties of the Conjugated Ethylene-Vinyl Ester Copolymers Obtained in the Invention

The number of conjugates introduced will depend on the number of priming sites generated before the conjugation step. Conjugate size or length defined by p (p1 in the group Q1 or p2 in the group Q2) is dependent on the number of priming sites in the activated polymer and the amount of ester monomer added in the conjugation step. At a constant level of ester monomer, the greater the number of sites, the smaller will be the conjugate; conversely, the greater the number of sites, the longer will be the conjugate. Molar masses of the copolymers according to the invention, as measured by GPC, are over 10,000 g.mol⁻¹, preferably between 10,000 and 40,000 g.mol⁻¹, more preferably between 10,500 and 30,000 g.mol⁻¹, and more preferably still between 12,000 and 20,000 g.mol⁻¹.

According to the invention, the conjugated ethylene-vinyl ester polymers with a molar mass of over 10,000 g.mol⁻¹ include:
a) an ethylene-derived group of structure A —(CH₂—CH₂)ₙ—;
b) at least one group of structure B: —(CH₂—CHOCOR₁)ₘ₋ₓ— in which R₁ is at least one residue selected from the groups of linear or branched alkyl groups C₁-C₁₅;
c) one group of structure C: —(CH₂—CHOH)ₓ₁—;
d) at least one group of structure D: —(CH₂—CHG)ₓ₂- or of structure D′ —CH₂C(OCOCH₃)Q)ₓ₂- in which G corresponds to a group of structure G1 or G2 or G3 in which:
   G1 corresponds to the structure —OCOCHCH₃Q-;
   G2 corresponds to the structure —OCOCH₂Q-;
   G3 corresponds to the structure —OCOCH₂SQ-;
in which Q represents
   either a group of structure Q1 —(CH₂—CZCOOR)ₚ₁—X_{q};
   or a group of structure Q2 —(CH₂—CZOCOR)ₚ₂—X_{q};
   in which X corresponds to a halogen atom, preferably Br or I, q ranges from 0 to 1, Z corresponds to a hydrogen atom or a CH₃ group, and R corresponds to a linear or branched alkyl group, either saturated or unsaturated, C₁-C₃₀, preferably C₄-C₁₅, advantageously C₆-C₁₅ and more advantageously still C₆-C₁₂, and more particularly 2-ethylhexylacrylate;
copolymer in which:
n is between 48 and 643, and is preferably between 79 and 515
m is between 5 and 105, and is preferably between 10 and 71
x (x=x₁+x₂) is between 0.25 and 52, and is preferably between 0.5 and 36
x₁ is between 0 and 0.95 x, preferably x₁=0
x₂ is between 0.05 x and x, preferably x₂=x
p₁ ranges from 1-800, and is preferably between 1 and 50.
p₂ ranges from 1-100, and is preferably between 1 and 6.

The molar percentage of A groups in the polymer is 29 to 97% mol, preferably 54 to 90% mol or, in an equivalent fashion, the weight percentage of A groups in the polymer is 7-81%, preferably 20-62%; The molar percentage of B groups in the polymer is 1 to 20% mol, preferably 3.5 to 11% mol or, in an equivalent fashion, the weight percentage of B groups in the polymer is 1-64%, preferably 4-25%; The molar percentage of C groups in the polymer is 0-10% mol, preferably 0% mol or, in an equivalent fashion, the weight percentage of C groups in the polymer is 0-7%, preferably 0%; The molar percentage of D groups in the polymer is 0.6-64% mol preferably 2.3-42% mol or, in an equivalent fashion, the weight percentage of D groups in the polymer is 10-85%, preferably 16-75%; The molar percentage of Q in D: from 8.2-99.9% mol, preferably from 35-98.7% mol or, in an equivalent fashion, the weight percentage of Q in D: from 30-99.9% mass, preferably from 50-99.3%.

Properties:

Conjugation enhances the solubility of the copolymers in hydrocarbons. For middle distillates treated with copolymers of the invention, this improves LFT filterability characteristics as measured according to SOP IP387. In practice, the enhanced solubility of the conjugated polymer prevents the insoluble fraction from blocking the filter (which commonly has a pore size of 1.6 micron) and reduces the Filter Blocking Tendency (FBT) compared with the initial copolymer. This improvement in FBT is observed whatever the amount of conjugated polymer (whatever the molar percentage of the group Q in the group D).

For EVA with a low VA concentration (below 32% by weight), conjugation modifies its rheological behaviour in concentrated solutions, e.g. a solution of 70% wt. of polymer in an aromatic petroleum fraction. In practice, such a concentrated EVA solution shows thixotropic behaviour at 40° C. with high viscosity at low shearing gradients, i.e. a high pour threshold. Conjugation endows this type of concentrated solution of an EVA copolymer with Newtonian behaviour with lower viscosity than the initial EVA, especially at low shearing forces (≦10 s-1).

When the proportion of VA exceeds 32% by weight, Newtonian behaviour is restored to the starting copolymer in a solution of 70% copolymer by weight, and conjugation does not further improve the copolymer's rheological properties. In all cases, independently of variations in rheological behaviour, conjugation improves polymer solubility which makes it easier to handle. It also makes it easier to make up more concentrated polymer solutions.

Description of the Concentrated Additive Solutions According to the Invention

Starting with conjugated copolymers according to the invention, concentrated polymer solutions can be made up, in particular solutions containing between 50 and 80% by weight, preferably between 60 and 70% by weight of polymer in a solvent such as an aliphatic or aromatic hydrocarbon. Despite their high concentration, the viscosity of these solutions remains within acceptable limits for the usual handling operations for hydrocarbon additives.

Description of Distillates, Fuels and Heating Oils Containing Additives According to the Invention

The copolymers according to the invention are added as filterability additives to distillates, fuels and heating oils. Distillates containing at least a major part of a middle distillate-type hydrocarbon fraction with a sulphur content of less than 5,000 ppm, preferably less than 500 ppm, and more preferably still less than 50 ppm, and a minor part of at least one double-purpose filterability and flow additive according to the invention. These distillates are represented by distillates that boil between 150 and 450° C., with a crystallisation commencement temperature Tcc greater than or equal to −5° C., preferably between −5° C. and +10° C., and including distillates from direct distillation, vacuum distillates, hydroprocessed distillates, distillates generated by catalytic cracking and/or hydro-cracking of vacuum distillates, distillates resulting from ARDS (atmospheric residue desulphuration) conversion and/or visco-reduction processes, distillates from the recovery of Fischer Tropsch fractions, distillates generated by BTL (biomass-to-liquid) conversion of plant- and/or animal-derived material, used alone or in combination, and esters of plant- and/or animal-derived lipids or mixtures thereof.

Of course, this invention is not restricted to the described examples and embodiments but many variants could be envisaged by those skilled in the art.

Example of Conjugated Polymer Preparation:

Two grades of starting ethylene-vinyl acetate (EVA) copolymer were tested and are hereafter referred to as P1 and P2: P1 corresponds to a starting polymer containing A groups in which n=130 and B corresponds to the structure —(CH₂—CHOCOR₁)ₘ— in which m=16 and R₁ is CH₃. P2 corresponds to a starting polymer containing A groups in which n=125 and B corresponds to the structure —(CH₂—CHOCOR₁)ₘ— in which m=18 and R₁ is CH₃.

ATRP Process:

The first two steps are carried out as described in the first two steps of Garcia F. G. et al. in Eur Polym J. 2002, 38, 759, corresponding to the hydrolysis and esterification of OH sites. However, for the ATRP polymerisation, a catalytic pairing of CuCl and Bipyridine is used instead of that of CuBr and PMDETA.

### EXAMPLE 1

As shown in the process outlined below, conjugation is achieved using EVA. The conjugation reaction is monitored using proton NMR.

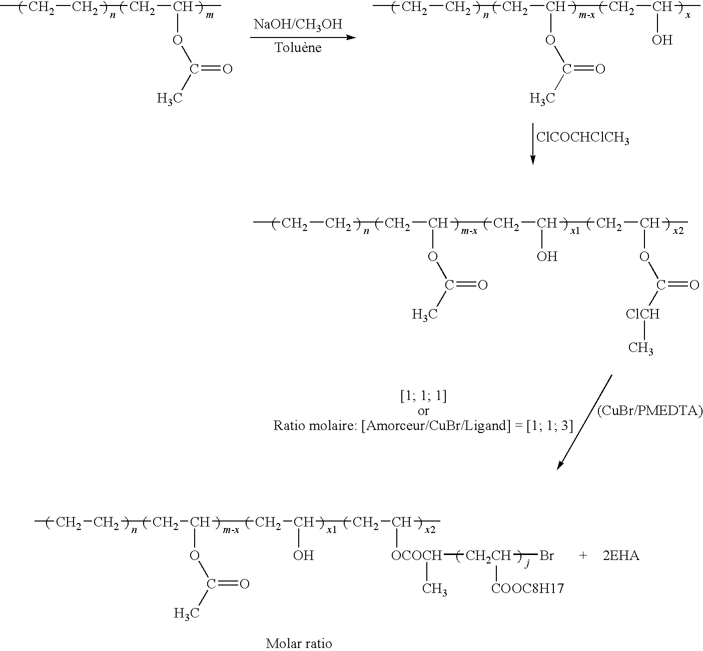

1) The first step is hydrolysis by alkaline methanolysis with a 10% wt. solution of sodium hydroxide in methanol. The efficiency of conversion of vinyl acetate groups into vinyl alcohol groups will depend on the volume of alkali added. Thus, varying the hydrolysis rate dictates the number of polyacrylate conjugates.

2) the second step is esterification of the OH groups using chloracetyl chloride. The efficiency of OH esterification is dependent on the amount of the chlorine derivative added. Since the objective is to limit the concentration of OH groups, at least one equivalent of chloracetyl chloride per OH group will be added: thus, when two equivalents of the chlorine derivative are added, esterification is total in the presence of triethylamine (without triethylamine or with a less-than-stoichiometric amount of the chlorine derivative, the reaction is partial.

3) The atom transfer radical polymerisation step has been adapted from that of Garcia to increase the monomer conversion rate and obtain a narrower size distribution.

This step, which uses the reaction of the CuBr/PMEDTA system with the primer obtained in step 2) gives exchange reactions with conversion of 84.5% of the monomer in five hours (measured by vapour phase chromatography [VPC]), and polymer size distributions of 1.18 (measured by CPV). A comparison with the catalytic system described by Garcia (CuCl/bipy) gave a lower conversion rate (61.5% in 22 hours) and broader size distributions (1.59). The above operating procedure carried out using 2 ethyl-hexyl-acrylate (2EHA) as the substituted vinyl monomer of structure M1 CH₂═CZCOOR in which R is the 2 ethyl-hexyl group has been reproduced with substituted vinyl monomers M1 in which the group R is butyl, lauryl or various mixtures of tridecyl, tetradecyl, pentadecyl, hexadecyl, eicosyl and steraryl groups.

When a simple free radical is used, the starting polymer is dissolved in an aromatic solvent (e.g. a kerosene fraction) at a temperature of 90° C. with stirring. Then, taking into account the breakdown temperature of the initiator and keeping the reaction medium under an inert gas (nitrogen or argon), the monomer and the initiator (peroxide) are added at a constant rate. In general, the proportion of peroxide is between 0.5 and 5% wt. with respect to the monomer to be polymerised.

When a free radical-mediated reaction with a sulphur derivative-type transfer macroagent is chosen, the VA groups are partially hydrolysed then esterification is carried out with mercapto-acetic acid. This yields a mercapto-modified EVA which is used as a chain transfer agent in acrylate polymerisation initiated by AIBN. When a free radical-mediated reaction with a halogen derivative-type transfer macroagent is chosen, the first step is to prepare an ethylene-vinyl chloroacetate by transesterification of the EVA and the chloroacetic acid in the presence of mercury sulphate at room temperature. Then ethylene vinyl iodoacetate is generated by reacting the ethylene vinyl chloroacetate with potassium iodide (KI).

Finally, the acrylate monomer is polymerised with AIBN initiation. Reference could be made to the processes described by Garcia F. G. et al., Polym. Int. 2002, 51, 1340-1347 and Teodorescu M. et al., Reactive & Functional Polymers 2004, 61, 387-395.

### EXAMPLE 2

### Prepared Products

The molar masses of the prepared products as measured by GPC calibrated with polystyrene standards all fall within the range of 10,000-30,000 g.mol−1. The characteristics of the prepared products are shown in Table 1.

TABLE 1

| | | | conjugated polymer | | | | |
|---|---|---|---|---|---|---|---|
| | starting | nature of | % mol | % mol | % mol | % mol | % mol |
| Ref | polymer | conjugation | A (n) | B (m-x) | C (x1) | D (x2) | Q1 in D (p1) |
| 1 | P1 | none | 88.8 (130) | 11.2 (16) | 0 (0) | 0 (0) | 0 (0) |
| 2 | P1 | 2EHA | 79.7 (130) | 8.9 (14.2) | 0 (0) | 11.4 (1.8) | 94.9 (22) |
| 3 | P1 | 2EHA | 81.4 (130) | 5.6 (8.7) | 0 (0) | 12.9 (7.3) | 83.4 (6) |
| 4 | P1 | 2EHA | 84 (130) | 9.2 (14) | 0 (0) | 6.7 (2) | 88 (7.4) |
| 5 | P1 | 2EHA | 86.9 (130) | 8.2 (12) | 0 (0) | 4.95 (4) | 69.4 (3) |
| 6 | P1 | 2EHA | 80.4 (130) | 7.6 (12) | 0 (0) | 12 (4) | 87.4 (8.4) |
| 7 | P1 | 2EHA | 80.5 (130) | 5.6 (8) | 2.3 (4) | 11.6 (4) | 87.9 (8) |
| 8 | P1 | butyl acrylate | 82.8 (130) | 8.8 (13.4) | 0 (0) | 8.45 (2.6) | 89.1 (8) |
| 9 | P1 | lauryl | 85.2 (130) | 9 (13.4) | 0 (0) | 5.8 (2.6) | 81.3 (4.4) |
| | | acrylate | | | | | |
| 10 | P1 | methacrylate | 87 (130) | 9.6 (14) | 0 (0) | 3.4 (2) | 75.2 (2.9) |
| | | C12-C15 | | | | | |
| 11 | P1 | methacrylate | 86.3 (130) | 9.2 (13.4) | 0 (0) | 4.6 (2.6) | 75.8 (3.1) |
| | | C16-C18 | | | | | |
| 12 | P1 | acrylate | 84.9 (130) | 10.8 (13.4) | 0 (0) | 4.3 (2.6) | 76.3 (3) |
| | | C18-C22 | | | | | |
| 13 | P1 | copo | 77.7 (130) | 8.6 (14) | 0 (0) | 13.7 (2) | 91.5 (11) |
| | | (2EHA/MA | | | | | |
| | | C12-C15) | | | | | |
| 14 | P1 | veova10 | 86.6 (130) | 9.5 (13.7) | 0 (0) | 3.9 (2.3) | 78.6 (3.8) |
| 15 | P2 | none | 87.5 (124) | 12.5 (18) | 0 (0) | 0 (0) | 0 (0) |
| 16 | P2 | 2EHA | 81.6 (124) | 9.9 (15.3) | 0 (0) | 8.4 (2.7) | 87.2 (7) |
| 17 | P2 | 2EHA | 74.4 (124) | 9.1 (15.3) | 0 (0) | 16.5 (2.7) | 93.9 (15) |
| 18 | P2 | 2EHA | 77.5 (124) | 7.5 (12.2) | 0 (0) | 15 (5.8) | 85.7 (5.9) |
| 19 | P2 | 2EHA | 80.5 (124) | 7.8 (12.2) | 0 (0) | 11.7 (5.8) | 81.3 (3.3) |

x = x₁ + x₂

The value of p1 corresponds to the extent of polymerisation of Q1 in D. Samples 1 and 15 are reference samples for both of the grades of EVA tested, i.e. P1 or P2. Samples 2 and 3 have the same amount of polyacrylate but not the same number of conjugates: Sample 3 has four times as many conjugates as sample 2, and therefore conjugates that are four times shorter since the polyacrylate content is the same.

Of the conjugated 2EHA samples (2 to 7), samples 4 and 5 contain less 2EHA polyacrylate than the others (cf. the % mol D column). Samples 8 to 12 carry polyacrylate cognates with different alkyl chains. Sample 8 has conjugates of poly(butyl acrylate). Sample 9 has conjugates of poly(lauryl acrylate).

Sample 10 has conjugates which are a mixture of {poly(lauryl methacrylate) (20-30%), poly(tridecyl methacrylate) (25-35%), poly(tetradecyl methacrylate) (25-35%), and poly(pentadecyl methacrylate) (15-25%)}. Sample 11 has conjugates which are a mixture of {poly(stearyl methacrylate) (60-75%), poly(hexadecyl methacrylate) (22-35%), poly(eicosyl methacrylate) (<2%)}. Sample 12 has conjugates which are a mixture of {poly(stearyl acrylate) (40-46%), poly(eicosyl acrylate) (8-14%), poly(behenyl acrylate) (42-48%)}. Sample 13 has mixed conjugates on 2EHA+mixed C12-C15 methacrylate=mixture {poly(lauryl methacrylate) (20-30%), poly(tridecyl methacrylate) (25-35%), poly(tetradecyl methacrylate) (25-35%), and poly(pentadecyl methacrylate) (15-25%)}.

Sample 14 is conjugated with vinylneodecanoate. Samples 16 to 19 correspond to modifications of the P2 polymer: Sample 18 has the same number of conjugates as sample 19, but they are longer (because there is more polyacrylate in sample 18 than in sample 19).

Results

Efficacy tests for LFT, filterability (FBI) and viscosity were carried out on two types of fuel, Gz1 and Gz2, the characteristics of which are shown in Table 2. By virtue of its structure, the P2 polymer is more effective with Gz1, whereas the P1 polymer is more effective with Gz2.

TABLE 2

| Reference | Gz1 | Gz2 |
|---|---|---|
| Paraffin content (measured by LC/GC) | | |
| <C13 | 4.53 | 2.05 |
| C13-C17 | 8.61 | 4.58 |
| C18-C23 | 5.47 | 4.64 |
| >C24 | 0.66 | 0.94 |
| TOTAL n-Paraffins (% wt.) | 19.27 | 12.21 |
| LFT (° C.) | −4 | 1 |
| PTE (° C.) pour point temperature | −12 | −6 |
| PT (° C.) cloud point | −4 | 2 |
| MV15 | 0.8327 | 0.8541 |
| Sulphur content (ppm) | 39.8 | 930 |
| Viscosity at 40° C. (mm²/s) | 2.725 | 2.6348 |
| Ketane calculated D4737 | 50.1 | 44.8 |
| Aromatic content IP391 | | |
| Mono Aromatics % | 22.7 | 26.6 |
| Di Aromatics % | 6.2 | 9.1 |
| Poly Aromatics % | 0.6 | 1.9 |
| TCC (° C.) crystallisation commencement | −7/−6.2 | −1.2 |
| temperature. | | |
| Distillation D86 (° C.) | | |
| Initial Point | 167.6 | 156.4 |
| T10 | 203 | 189.8 |
| T20 | 224.7 | 203.5 |
| T50 | 274.5 | 271.9 |
| T80 | 317.1 | 331.3 |
| T90 | 337.4 | 354.3 |
| T95 | 353.9 | 371.1 |
| Final Point | 356 | 373.4 |

Gz1 is a fuel with a sulphur content of below 50 ppm which contains less than 0.7% wt. n-paraffins with a carbon number of over 24, and a C18-C23 paraffin concentration of over 5%; its TCC is below −5° C. Gz2 is a fuel with a sulphur content of below 5000 ppm which contains more than 0.7% wt. n-paraffins with a carbon number of over 24 and a TCC of over −5° C.

LFT is measured as stipulated in the NF EN116 Norm. Polymers P1 and P2 present jumps in LFT efficacy at concentrations close to 140 ppm (Gz2) and 210 ppm (Gz1). The LFT performance of modified polymers was measured at these two concentrations and compared with those of the corresponding starting polymers.

The viscosity of the polymers was measured on a solution diluted with 30% wt. Solvarex 10 (an aromatic petroleum fraction) at 40° C., using a titanium, constrained rheometre with cone-plane geometry (20 mm/2°), with a solvent trap. FBT (Filter Blocking Tendency) was measured using the IP 387 method which is equivalent to “solubility measurement” of the additive in the fuel. The additive is well dissolved if FBT<1.41. The results are shown in Table 3.

TABLE 3

| | | LFT | LFT | | Viscosity |
|---|---|---|---|---|---|
| | | (at 140 ppm) | (at 210 ppm) | | (at 10 s−1) |
| Reference | Distillate | (° C.) | (° C.) | FBT | (Pa · s) |
| 1 | Gz1 | −14 | −16 | 10.05 | 5.9 |
| 2 | Gz1 | −17 | −18 | 1.05 | 3.6 |
| 3 | Gz1 | −15 | −16 | 1.05 | 0.98 |
| 4 | Gz1 | −14 | −16 | 1.11 | 5 |
| 5 | Gz1 | −15 | −16 | 1.06 | 2.5 |
| 6 | Gz1 | −17 | −18 | 1.05 | 2 |
| 7 | Gz1 | −13 | −18 | | |
| 8 | Gz1 | −8 | −13 | 1.18 | 3.7 |
| 9 | Gz1 | −12 | −15 | 1.01 | 0.8 |
| 10 | Gz1 | −13 | −14 | 1.03 | |
| 11 | Gz1 | −3 | −3 | 1.02 | 12.4 |
| 12 | Gz1 | −3 | −3 | 3.48 | 15.3 |
| 13 | Gz1 | −17 | −16 | 1.01 | |
| 14 | Gz1 | −8 | −12 | | 10 |
| 15 | Gz1 | −14 | −17 | 3.88 | 1.9 |
| 16 | Gz1 | −15 | −17 | 1.06 | 2.5 |
| 17 | Gz1 | −13 | −17 | 1.05 | |
| 18 | Gz1 | −8 | −8 | 1.05 | 5 |
| 19 | Gz1 | −14 | −14 | 1.05 | 1.9 |
| 1 | Gz2 | −11 | −12 | | |
| 2 | Gz2 | −13 | −12 | | |
| 3 | Gz2 | 0 | −2 | | |
| 4 | Gz2 | −10 | −10 | | |
| 5 | Gz2 | −1 | −10 | | |
| 6 | Gz2 | −2 | −10 | | |
| 7 | Gz2 | 0 | −3 | | |
| 9 | Gz2 | −3 | −10 | | |
| 13 | Gz2 | −9 | −10 | | |
| 14 | Gz2 | −6 | −9 | | |

Samples 1 and 15 are reference samples for both of the grades of EVA tested, i.e. P1 or P2. It is worth noting that, by virtue of its characteristics, Gz2 is far more “discriminating” than Gz1 when it comes to efficacy vis-à-vis LFT. Samples 2 and 3 contain the same amount of polyacrylate but not the same number of conjugates: Sample 3 carries four times as many conjugates as sample 2, and therefore the conjugates are four times shorter since the polyacrylate content is the same.

In terms of LFT efficacy, it can be seen that sample 2 is effective in both types of distillate (Gz1 and Gz2) whereas sample 3 is only effective in Gz1. In practice, too high a degree of conjugation (% mole B>7.5% mol) on P1 heavily modifies the starting polymer's original structure, compromising its efficacy as is more apparent in Gz2. Both are highly soluble (FBT<1.41).

By virtue of its many conjugates, sample 3 has the advantage of being far more fluid than the starting polymer P1. Of the conjugated 2EHA samples (2 through 7), samples 4 and 5 contain less polyacrylate than the others (cf. the % mol D column) but it can be seen that, even with a lower polyacrylate content, efficacy is seen in terms of LFT, solubility (FBT<1.41) and viscosity. If the effect is examined in the presence of C groups—sample 7 which can be compared with sample 6 because they have the same number of conjugates for the same amount of polyacrylate—it can be seen that the presence of C diminishes LFT efficacy in Gz1 (sample is 6 effective from 140 ppm up whereas efficacy is not seen with sample 7 below 210 ppm) and, more importantly, they compromise efficacy in Gz2.

Samples 8 to 12 carry polyacrylate conjugates with different alkyl chains. They can be compared to sample 2 which has conjugates of poly(2-ethyl hexyl acrylate). It can be seen that the LFT efficacy of sample 8 is diminished in Gz1 and that samples 11 and 12 are not at all effective in Gz1. These samples—in which the alkyl chains of the conjugated acrylates contain more than 15 carbon atoms—do not act as “seeders” and are more active as cloud point additives in that they solubilise the paraffins.

Thus, the most effective samples vis-à-vis LFT are those with poly(alkyl (meth)acrylate) conjugates with an alkyl chain of between C6 and C15. Moreover, they all dissolve well (FBT<1.41) apart from sample 12. Conjugated polymer viscosity is lowest with conjugates of 2-ethyl hexyl polyacrylate and lauryl polyacrylate. Samples 11 and 12 containing more crystalline n-alkyl poly(meth)acrylate are more viscous. Conjugating C16-C22 poly(meth)acrylate does not reduce the viscosity of the starting copolymer.

Sample 13 is highly effective vis-à-vis LFT in Gz1 and Gz2. It also dissolves efficiently (FBT<1.41). Sample 14 is conjugated with vinylneodecanoate: its LFT efficacy is diminished in Gz1 but it works well in Gz2. On the other hand, it is more viscous than P1. Of samples 16 to 19, only sample 18 does not work with respect to LFT in Gz1: if it is compared to sample 19, it is carrying the same number of conjugates but they are longer (because sample 18 contains more polyacrylate than sample 19). There is therefore a conjugate size which cannot be exceeded (i.e. a maximum amount of polyacrylate) for a given number of conjugates.

All the samples are soluble (FBT<1.4) but no improvement in viscosity is seen with respect to P2. An improvement in viscosity is only seen at shearing forces of under 10 s⁻¹, e.g. with sample 19 which is Newtonian unlike P2 which is thixotropic; NB the P1 polymers show less thixotropy.

1. A conjugated ethylene-vinyl ester copolymer, with a molar mass of over 10,000 g.mol⁻¹ comprising containing:
a) an ethylene-derived group of structure A —(CH₂—CH₂)ₙ— in which n is a whole number of between 45 to 650;
b) at least one group of structure B: —(CH₂—CHOCOR₁)ₘ₋ₓ— in which m is a whole number of between 5 to 110, and R₁ is at least one residue selected from the groups of linear or branched alkyl groups, C₁-C₁₅;
c) one group of structure C: —(CH₂—CHOH)ₓ₁— in which x1 ranges from 0 to 0.95 x;
d) at least one group of structure D: —(CH₂—CHG)ₓ₂- or of structure D′ —CH₂C(OCOCH3)Q)ₓ₂- in which x₂ is never 0 and ranges from 0.05 x to x, and G corresponds to a group of structure G1 or G2 or G3 where
G1 corresponds to the structure —OCOCHCH₃Q-
G2 corresponds to the structure —OCOCH₂Q-
G3 corresponds to the structure —OCOCH₂SQ-
in which Q corresponds to
either a group of structure Q1 —(CH₂—CZCOOR_{q1})ₚ₁—X_{q} in which p₁ ranges from 1 to 800;
or a group of structure Q2 —(CH₂—CZOCOR_{q2})ₚ₂—X_{q} in which p₂ ranges from 1 to 100;
in which X corresponds to a halogen atom, q ranges from 0 to 1, Z corresponds to a hydrogen atom or a CH₃ group, and R_{q1} or R_{q2} corresponds to a linear or branched alkyl group, either saturated or unsaturated, C₁-C₃₀,
copolymer in which
x=x₁+x₂ and x ranges from 0.25 to 55;
the molar percentage of A groups in the polymer is 29-97% in moles;
the molar percentage of B groups in the polymer is 1-20% in moles;
the molar percentage of C groups in the polymer is 0-10% in moles;
the molar percentage of D or D′ groups in the polymer is 0.6-64% in moles and the molar percentage of 0 in D or D′ is de 8.2-99.9% in moles.

2. The conjugated ethylene-vinyl ester copolymer according to claim 1, with a molar mass of between 10500 and 30000 g.mol⁻¹, further comprising:
a) an ethylene-derived group of structure A —(CH₂—CH₂)ₙ— in which n is a whole number of between 45 to 650;
b) at least one group of structure B: —(CH₂—CHOCOR₁)ₘ₋ₓ— in which m is a whole number of between 5 to 110, and R₁ is at least one residue selected from the groups of linear or branched alkyl groups C₁-C₁₅;
c) one group of structure C: —(CH₂—CHOH)ₓ₁— in which x₁ ranges from 0 to 0.95 x;
d) at least one group of structure D: —(CH₂—CHG)ₓ₂- in which x₂ is never 0 and ranges from 0.05 x to x, and G corresponds to a group of structure G1 —OCOCHCH₃Q- in which Q corresponds to:
either a group of structure Q1 —(CH₂—CZCOOR_{q1})ₚ₁—X_{q} p₁ ranges from 1 to 800;
or a group of structure Q2 —(CH₂—CZOCOR_{q2})ₚ₂—X_{q} p₂ ranges from 1 to 100;
in which X corresponds to a halogen atom, q ranges from 0 to 1, Z corresponds to a hydrogen atom or a CH₃, and R_{q1} or R_{q2} corresponds to a linear or branched alkyl group, either saturated or unsaturated, C₁-C₃₀,
copolymer in which
x=x₁+x_{2 and} x ranges from 0.25 to 55;
the molar percentage of A groups in the polymer is 29-97% in moles
the molar percentage of B groups in the polymer is 1-20% in moles
the molar percentage of C groups in the polymer is 0-10% in moles
the molar percentage of D groups in the polymer is 0.6-64% in moles,
and the molar percentage of Q in D goes from 8.2-99.9% in moles.

3. The polymer according to claim 1 in which Q represents a group of structure Q1 —(CH₂—CZCOOR_{q1})ₚ₁—X_{q} in which q is 0, and p₁ ranges from 1 to 50.

4. The polymer according to claim 1 in which R_{q1} corresponds to a linear or branched alkyl group, either saturated or unsaturated, C₆-C₁₅.

5. The polymer according to claim 1 in which Q represents a group of structure Q2 —(CH₂—CZOCOR_{q2})ₚ₂—X_{q} in which q is 0, p₂ ranges from 1 to 10, Z is H, and R_{q2} corresponds to a branched alkyl group, C₅ to C₂₅, in which the branch point may be anywhere in the alkyl chain.

6. The polymer according to claim 5 in which the group OCO R_{q2} is selected from the groups of pivalate, isopentanoate, isohexanoate, 2-ethylhexanoate, isononanoate, isodecanoate, isotridecanoate, neononanoate, neodecanoate and neoundecanoate.

7. The polymer according to claim 1 in which the OCOR_{q2} radical is derived from plant- or animal-derived fatty acids in which the group R_{q2} contains alkyl chains, either saturated or unsaturated, linear or branched C₈ to C₂₅.

8. The polymer according to claim 1 in which the group of structure B corresponds to:
a) either a group of structure B′ —(CH₂—CHOCOR′₁)_{m′-x} in which R′₁ is a CH3 group, and m′ ranges from 10 to 75;
b) or a group of structure B″ —(CH₂—CHOCOR″₁)^{m″-x}, in which R″₁ is the group C₂H₅, and m″ ranges from 10 to 75;
c) or a group of structure B′″ —CH₂—CHOCOR′″¹)_{m′″-x}, in which R′″ is a branched alkyl chain, C₅ to C₁₅, in which the branch point may be anywhere in the alkyl chain, and m′″ ranges from 10 to 75;
or a mixture thereof.

9. The polymer according to claim 1 in which:
n=79 to 515;
the group of structure B represents a group of structure B′ —(CH₂—CHOCOR′₁)_{m′-x} in which R′₁ is a CH3 group, and m′ ranges from 10 to 71;
x ranges from 0.5 to 36 with x1=0;
Q represents a group of structure Q1 —(CH₂—CHCOOR)ₚ₁—X_{q} in which q is 0, p1 ranges from 1 to 50, and R corresponds to a linear or branched alkyl group, either saturated or unsaturated, C₁-C₃₀, or preferably C₄-C₁₅;
the molar percentage of A groups in the polymer is 54-90% in moles;
the molar percentage of B groups in the polymer is 3.5%-11% in moles;
the molar percentage of C groups in the polymer is 0% in moles;
the molar percentage of D groups in the polymer is 2.3%-42% in moles; and
the molar percentage of Q in the group D is 35%-98.7% in moles.

10. A process for preparation of the conjugated polymers comprising:
i) supplying a starting ethylene-vinyl ester polymer comprising:
a) ethylene-derived groups of structure A —(CH₂—CH₂)ₙ—;
b) at least one group of structure B: —(CH₂—CHOCOR₁)ₘ— in which R₁ is at least one residue selected from the groups of linear or branched alkyls, C₁-C₁₅; a CH₂SH or CH₂I group;
n and m ranging so that the mean Mn of the starting polymer ranges from 3000 to 20000 g.mol⁻¹; followed by:
ii) introducing a free radical initiator and free radical-catalysed polymerisation at the priming sites of a polymerisable monomer of structure M1 CH₂═CZCOOR, or possibly of structure M2 CH₂═CZOCOR, a monomer M1 or M2 in which Z corresponds to a hydrogen atom or a CH₃ group, the group R corresponding to a linear or branched alkyl group, either saturated or unsaturated, C₁-C₃₀, reacting in such a way that the extent of polymerisation p1 of the monomer M1 to give the group Q1 at the priming site goes from 1 to 800, or possibly the extent of polymerisation p2 of the monomer M2 to give the group Q2 at the priming site goes from 1 to 100.

11. The process according to claim 10 for the preparation of the conjugated polymers comprising:
j) supplying a starting ethylene-vinyl ester polymer comprising:
a) ethylene-derived groups of structure A —(CH₂—CH₂)ₙ—;
b) at least one group of structure B: —(CH₂—CHOCOR₁)ₘ— in which R₁ is at least one residue selected from the groups of linear or branched alkyls, C₁-C₁₅;
n and m ranging so that the mean Mn of the starting polymer ranges from 3000 to 20000 g.mol₋₁; followed by:
jj) partial hydrolysis of the alkyl esters present in the group B such that the hydrolysis efficiency is less than or equal to 50% of the hydrolysable sites; followed by:
jjj) partial esterification of these sites with a halide of halogenic acid of structure XOC—CH₂₋ⱼXⱼ—CH₃ in which j is 1 or 2, and X represents a halogen atom, such that the esterification efficiency is greater than 50% preferably 100%; followed by:
jjjj) polymerisation at the priming sites carrying a halogen atom, of a monomer of structure M1 CH₂ ═CZCOOR, or possibly of a monomer of structure M2 CH₂═CZOCOR, a monomer in which Z corresponds to a hydrogen atom or a CH₃ group, the group R corresponding to a linear or branched alkyl group, either saturated or unsaturated, C₁-C₃₀, reacting in such a way that the extent of polymerisation p1 of the monomer M1 to give the group Q1 at the priming site goes from 1 to 50, or possibly the extent of polymerisation p2 of the monomer M2 to give the group Q2 at the priming site goes from 1 to 6.

12. The preparation process according to claim 11 in which the step jjjj) is achieved by atom transfer radical polymerisation (ATRP) in the presence of a catalytic system including a transition metal and a nitrogen-containing ligand.

13. The preparation process according to claim 11 in which the step jjjj) is achieved by free radical-mediated polymerisation in the presence of a free radical initiator.

14. The preparation process according to claim 11 in which the step jj) is followed by a step kkk) involving the conjugation of a functionalised polyacryate of structure TOC—(CH2—CHCOOR)ₚ₁— in which p1 and R are as defined above and T represents a halogen atom, in particular Cl, or an OH group, onto the copolymer's partially hydrolysed alcohol groups generated in step jj).

15. The process according to claim 10 in which the efficiency of conjugation in the weight of copolymer groups Q1 or Q2 achieved by polymerisation of the M1 and M2 monomers at said priming sites ranges from 10 to 80%.

16. The process according to claim 10 for the preparation of copolymers with a molar mass over 10,000 g.mol⁻¹.

17. A concentrated solution of a according to claim 1 in a hydrocarbon distillate, at a concentration of over 50% wt.

18. A utilisation of the concentrated solution according to claim 17 as a filterability and flow additive for middle distillate-type hydrocarbons.

19. A utilisation according to claim 18 in hydrocarbons with a content of n-paraffins containing more than 18 carbon atoms of over 4% by weight.

20. A utilisation of the concentrated solution according to claim 17 as a base for fuels for diesel motors and domestic heating oils.

21. A double-purpose additive to improve the low-temperature filterability and flow of liquid hydrocarbons containing a conjugated polymer according to claim 1.

22. Middle distillates comprising at least a major component of a middle distillate-type hydrocarbon fraction with a sulphur content of less than 5000 ppm, and a minor component of at least one double-purpose filterability and flow additive according to claim 21.

23. The distillate according to claim 22 in which the major component is constituted by distillates boiling at between 150 and 450° C. with a crystallisation commencement temperature Tcc greater than or equal to −5° C., including distillates from direct distillation, vacuum distillates, hydroprocessed distillates, distillates generated by catalytic cracking and/or hydro-cracking of vacuum distillates, distillates resulting from ARDS (atmospheric residue desulphuration) conversion and/or visco-reduction processes, distillates from the recovery of Fischer Tropsch fractions, distillates generated by BTL (biomass-to-liquid) conversion of plant- and/or animal-derived material, alone or in combination, and esters of plant- and/or animal-derived lipids or mixtures thereof.

24. The distillate according to claim 23 with a content of n-paraffins containing more than 18 carbon atoms of over 4% in weight.

25. The distillate according to claim 23, in which the content of n-paraffins containing more than 24 carbon atoms is greater than or equal to 0.7%.

26. The distillate according to claim 23, in which the content of n-paraffins with a carbon number from C24 to C40 ranges from 0.7 to 2%.

27. A diesel fuel containing 0-500 ppm sulphur and at least one distillate according to claim 22.

28. A fuel containing a distillate according to claim 22 in which the minor component contains 10-5000 ppm of at least one double-purpose filterability and flow additive according to claim 21, possibly mixed with other additives such as detergents, dispersing agents, demulsifying agents, anti-foaming agents, biocides, deodorants, ketane improvers, anti-corrosion agents, and modifiers of friction, lubrication, combustion, cloud point, pour point, sedimentation and conductivity.

29. A heating fuel containing 0-5000 ppm sulphur and at least one distillate according to claim 22.

30. A heavy fuel containing at least one distillate according to claim 22.
